(19) United States
(12) Patent Application Publication
(10) Pub. No.: US 2024/0126489 A1
(43) Pub. Date: Apr. 18, 2024

(54) INFORMATION PROCESSING DEVICE AND PROGRAM

(71) Applicant: FUJIFILM CORPORATION, Minato-ku, Tokyo (JP)

(72) Inventor: Yuki KANAZAWA, Kanagawa (JP)

(21) Appl. No.: 18/263,891

(22) PCT Filed: Jan. 26, 2022
(86) PCT No.: PCT/JP2022/002856

§ 371 Date: Aug. 2, 2023

(30) Foreign Application Priority Data
Feb. 10, 2021 (JP) 2021-019920

(51) Int. Cl. G06F 3/12

(52) U.S. Cl. CPC G06F 3/1258; G06F 3/121; G06F 3/1259

(57) ABSTRACT

In the present invention, a display controller 33: displays a stop button 41 for temporarily stopping a process in progress, the stop button 41 being displayed on an operation screen in an operation panel 42 even in a case in which a stoppable job in progress does not exist; and in a case in which, when the stop button 41 is pressed, a job to be temporarily stopped does not exist, displays a list of completed jobs. In a case in which, when the stop button 41 is pressed, a job to be stopped exists, the display controller 33 temporarily stops the job in progress and displays a list of temporarily stopped jobs in progress and jobs awaiting execution.

### TECHNICAL FIELD

The technology according to the present disclosure relates to an information processing device and a program.

### BACKGROUND ART

Japanese Patent Application Laid-Open (JP-A) No. 2010-028372 discloses an image processing device configured to, in a case in which a stop key is pressed after a job starts, stop the job in a case in which elapsed time after starting the job is less than a threshold, and check the job progress in a case in which the elapsed time is the threshold or longer, and extract and display changeable setting items without stopping the job in a case in which the job setting is changeable at this time.

JP-A No. 2012-221068 discloses an image forming device configured to, in a case in which a stop key is implemented by a software button, allow a software stop key to be pressed preferentially over other software buttons.

JP-A No. 2019-130868 discloses an image processing device configured to, in a case in which a temporary stop request of a print job is received from a logged-in user, temporarily stop all jobs, display a list of only jobs whose job execution user ID matches the user ID of the logged-in user, and abort only selected jobs from the displayed list of the jobs.

### SUMMARY OF INVENTION

### Technical Problem

In recent years, a stop button for stopping a process in progress is displayed on an operation screen by software processing. In a case in which such a stop button is always displayed on the operation screen, in a case in which no stoppable process exists, pressing the stop button does not provide any status change, and it is difficult for a user to understand whether the stop button is pressed correctly.

An object of the technology according to the present disclosure is to provide an information processing device and a program that can make it easier for a user to understand the behavior when a stop button for stopping a process in progress is pressed, in a case in which no process to be stopped exits even in a case in which the stop button is displayed on an operation screen even in a case in which no stoppable process in progress exists, than in a case in which no status change occurs in a case in which the stop button is pressed.

### Solution to Problem

An information processing device of a first aspect includes a processor. The processor displays a stop button for stopping a process in progress on an operation screen even in a case in which no stoppable process in progress exists.

The processor displays a list of completed processes in a case in which no process to be stopped exists when the displayed stop button is pressed.

The processor stops the process in progress and displays a list of the stopped process in progress and a process awaiting execution in a case in which the process to be stopped exists when the displayed stop button is pressed.

In the information processing device of the second aspect, the processor notifies on the operation screen that no stoppable process exists in a case in which no process to be stopped exists when the displayed stop button is pressed, in the information processing device of the first aspect.

In the information processing device of the third aspect, the processor displays a screen on which settings of the process are changeable on the operation screen in a case in which only one process to be stopped exists when the displayed stop button is pressed, in the information processing device of the first aspect.

In the information processing device of the fourth aspect, an abort button for aborting the execution of the process is displayed on the screen on which the settings of the process to be stopped are changeable, in the information processing device of the third aspect.

In the information processing device of the fifth aspect, in a case in which the stop button is pressed in a state in which the stop button is not valid, the processor notifies on the operation screen that an operation of the stop button is invalid, in the information processing device of the first aspect.

In the information processing device of the sixth aspect, the state in which the stop button is not valid is a state in which execution of the process is impossible because a fault occurs in the device, in the information processing device of the fifth aspect.

In the information processing device of the seventh aspect, the stop button is a temporary stop button for temporarily stopping the process in progress, in the information processing device of any one of the first to sixth aspects.

A program of the eighth aspect causes a computer to execute:
displaying a stop button for stopping a process in progress on an operation screen even in a case in which no stoppable process in progress exists;
displaying a list of completed processes in a case in which no process to be stopped exists when the displayed stop button is pressed; and
stopping the process in progress and displaying a list of the stopped process in progress and a process awaiting execution in a case in which the process to be stopped exists when the displayed stop button is pressed.

### Advantageous Effects of Invention

The information processing device of the first aspect can make it easier for a user to understand the behavior when a stop button for stopping a process in progress is pressed, in a case in which no process to be stopped exits even in a case in which the stop button is displayed on an operation screen even in a case in which no stoppable process in progress exists, than in a case in which no status change occurs in a case in which the stop button is pressed.

With the information processing device of the second aspect, even in a case in which no process to be stopped by the stop button exists, it is possible to recognize that the user has pressed the stop button.

With the information processing device of the third aspect, the user can change the settings of the process whose execution has been stopped by the stop button without requiring any other operations.

With the information processing device of the fourth aspect, in a case in which it is desired to abort the execution of the process stopped by the user, it is possible to abort the execution of the process.

With the information processing device of the fifth aspect, even in a state in which the stop button is not valid, it is possible to recognize that the user has pressed the stop button.

With the information processing device of the sixth aspect, even in a state in which a fault occurs in the device and the stop button is not valid, it is possible to recognize that the user has pressed the stop button.

The information processing device of the seventh aspect can make it easier for the user to understand the behavior when a temporary stop button for temporarily stopping a process in progress is pressed, in a case in which no process to be temporarily stopped exits even in a case in which the temporary stop button is displayed on an operation screen even in a case in which no temporarily stoppable process in progress exists, than in a case in which no status change occurs in a case in which the temporary stop button is pressed.

The program of the eighth aspect can make it easier for a user to understand the behavior when a stop button for stopping a process in progress is pressed, in a case in which no process to be stopped exits even in a case in which the stop button is displayed on an operation screen even in a case in which no stoppable process in progress exists, than in a case in which no status change occurs in a case in which the stop button is pressed.

### BRIEF DESCRIPTION OF DRAWINGS

FIG. 1 is a diagram showing a system configuration of an image forming system of one embodiment of the present disclosure.

FIG. 2 is a block diagram showing a hardware configuration of an image forming device 10 in one embodiment of the disclosure.

FIG. 3 is a block diagram showing a functional configuration of the image forming device 10 in one embodiment of the disclosure.

FIG. 4 is a diagram showing one example of a so-called touch panel type operation panel 42 provided in the image forming device 10 in one embodiment of the disclosure.

FIG. 5 is a flowchart for describing an operation when a stop button 41 is pressed in the image forming device 10 of one embodiment of the disclosure.

FIG. 6 is a diagram showing a message display example displayed in the operation panel 42 indicating that a job operation is impossible.

FIG. 7 is a diagram showing a display example of a list screen of completed jobs displayed in the operation panel 42.

FIG. 8 is a diagram showing a job setting screen example displayed in the operation panel 42.

FIG. 9 is a diagram showing a screen example of a list of jobs in progress/jobs awaiting execution displayed in the operation panel 42.

### DESCRIPTION OF EMBODIMENTS

Next, an embodiment of the present disclosure will be described in detail with reference to the drawings.

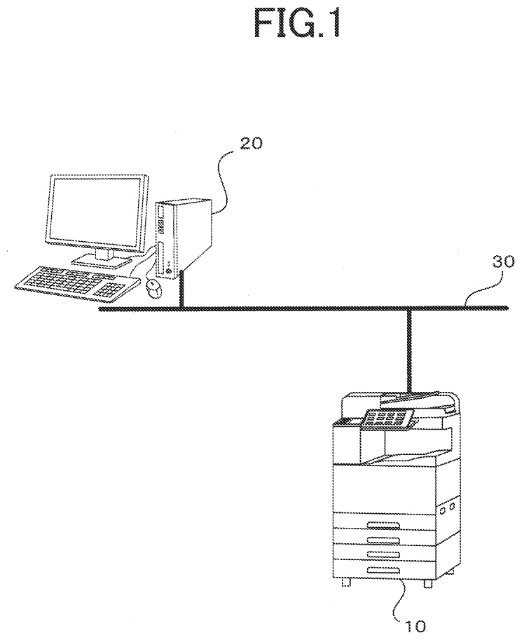

FIG. 1 is a diagram showing a configuration of an image forming system of one embodiment of the disclosure.

The image forming system of one embodiment of the disclosure includes an image forming device 10 and a terminal device 20 interconnected by a network 30, as shown in FIG. 1. The terminal device 20 generates print data and transmits the generated print data to the image forming device 10 via the network 30. The image forming device 10 receives the print data transmitted from the terminal device 20 and outputs an image according to the print data on paper. The image forming device 10 is a so-called multifunction device having multiple functions such as a printing function, a scanning function, a copying function, and a facsimile function.

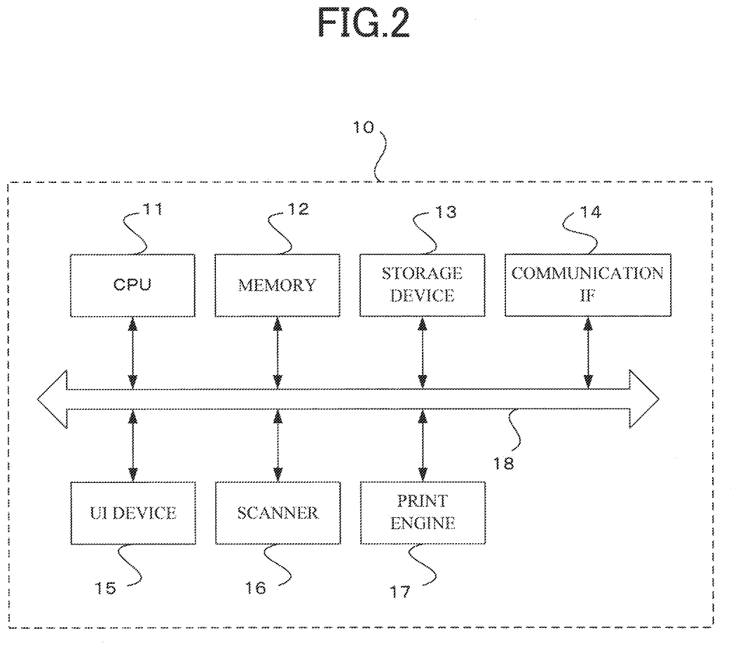

Next, FIG. 2 shows a hardware configuration of the image forming device 10 in the image forming system of the present embodiment.

The image forming device 10 includes, as shown in FIG. 2, a CPU 11, a memory 12, a storage device 13 such as a hard disk drive, a communication interface (abbreviated as IF) 14 for transmitting and receiving data to and from an external device and the like via the network 30, a user interface (abbreviated as UI) device 15 including a touch panel or liquid crystal display and a keyboard, a scanner 16, and a print engine 17. These components are connected to each other via a control bus 18.

The print engine 17 prints an image on a recording medium, such as printing paper, through processes such as charging, exposure, development, transfer, and fixation.

The CPU 11 is a processor that executes a predetermined process based on a control program stored in the memory 12 or the storage device 13 to control the operation of the image forming device 10. Note that the present embodiment describes the CPU 11 as reading and executing the control program stored in the memory 12 or the storage device 13, but it is also possible to store the program in a storage medium such as a CD-ROM and provide the program to the CPU 11.

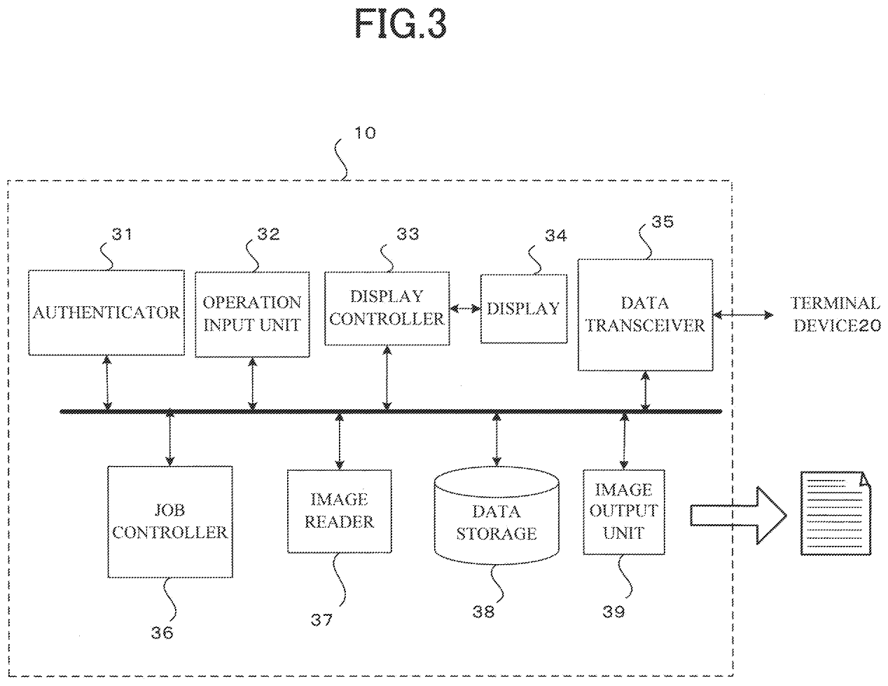

FIG. 3 is a block diagram showing a functional configuration of the image forming device 10 implemented by executing the control program.

The image forming device 10 of the present embodiment includes, as shown in FIG. 3, an authenticator 31, an operation input unit 32, a display controller 33, a display 34, a data transceiver 35, a job controller 36, an image reader 37, a data storage 38, and an image output unit 39.

The authenticator 31 executes an authentication process for a user who attempts to use the image forming device 10. The operation input unit 32 inputs various pieces of operation information executed by the user. The display controller 33 controls the display 34 and displays various pieces of information for the user. The data transceiver 35 transmits and receives data to and from an external device such as the terminal device 20.

The job controller 36 controls the operation for executing various jobs of the image forming device 10, and executes control to generate print data based on a print job received from the terminal device 20 via the data transceiver 35 and output the generated print data from the image output unit 39, control to read a document image by the image reader 37, and the like. The job here means various processes executed by the image forming device 10, such as a printing process, a scanning process, and a facsimile transmission process.

The job controller 36 executes various processes such as start of job execution, temporary stop of a job in progress, and abort of execution of a temporarily stopped job based on a job start instruction, a temporary stop instruction, and an abort instruction of a job in progress input from the user via the operation input unit 32.

The job controller 36 responds to an inquiry from the display controller 33 whether or not the job operation is possible, and to a request to acquire information on a job in progress, a job awaiting execution, and a completed job.

The image output unit 39 outputs an image on a recording medium such as printing paper under the control of the job controller 36. The image reader 37 reads a document image from the set document under the control of the job controller 36.

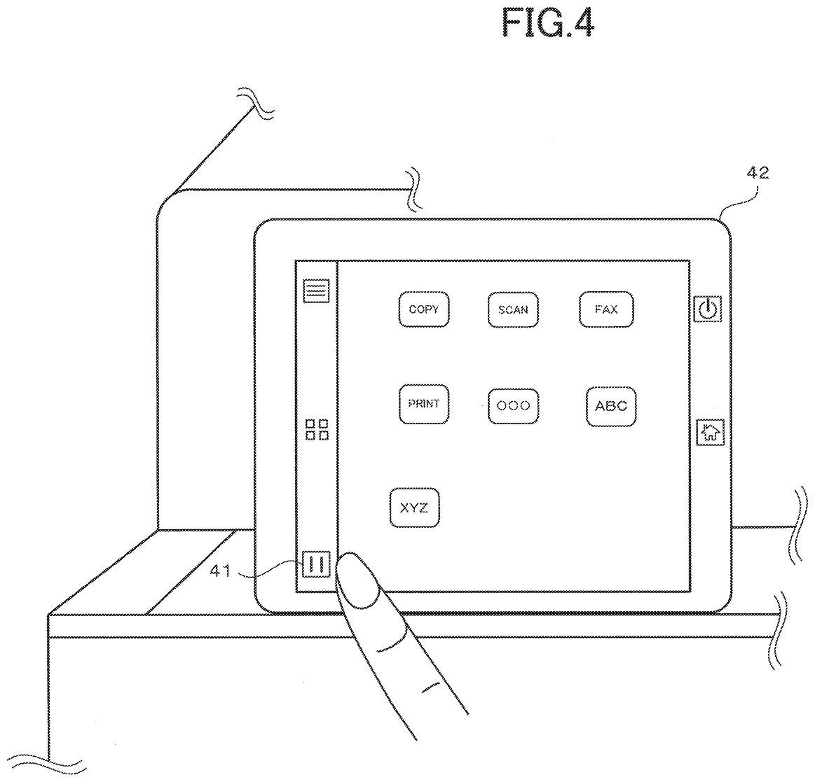

A so-called touch panel type operation panel includes the operation input unit 32 and the display 34 as components. One example of such an operation panel is shown in FIG. 4.

With reference to FIG. 4, an operation panel 42 including the operation input unit 32 and the display 34 is shown. It can be seen that a stop button 41, which is a temporary stop button for temporarily stopping a job in progress, is displayed by software in the display screen of the operation panel 42.

When the user presses the stop button 41, the job in progress is temporarily stopped. For example, in a case in which the user notices that a print job having a large number of pages is executed by mistake, the execution of the print job can be temporarily stopped by pressing the stop button 41 during the execution of the print job. In a case in which it is noticed that the transmission destination is wrong after the facsimile transmission is started, the user can stop the execution of the facsimile transmission by pressing the stop button 41.

In the present embodiment, the display controller 33 always displays the stop button 41 on the operation screen in the operation panel 42 even in a case in which no stoppable process in progress exists.

In a case in which such a stop button 41 is always displayed in the operation panel 42 by software, even if the user presses the stop button 41, reaction as with a hardware key is not obtained. Therefore, there is a problem that the user cannot obtain the feeling of pressing the stop button 41, and it is difficult to understand whether or not the stop button 41 is operated correctly.

In particular, in a case in which no job that is temporarily stoppable by the stop button 41 exists or in a case in which the stop button 41 is not in a valid state, unless something is displayed in the operation panel 42 by pressing the stop button 41, it is difficult for the user to know whether or not the stop button 41 is operated correctly.

Therefore, in the image forming device 10 of the present embodiment, the display controller 33 displays the stop button 41 for temporarily stopping the process in progress on the operation screen in the operation panel 42 even in a case in which no stoppable job in progress exists, and displays a list of completed jobs in a case in which no job to be temporarily stopped exists when the displayed stop button 41 is pressed.

In a case in which a job to be stopped exists when the displayed stop button 41 is pressed, the display controller 33 temporarily stops the job in progress and displays a list of temporarily stopped jobs in progress and jobs awaiting execution.

In a case in which no job to be stopped exists when the stop button 41 displayed on the operation screen in the operation panel 42 is pressed, the display controller 33 notifies on the operation screen in the operation panel 42 that no stoppable job exists.

In a case in which only one job to be stopped exists when the stop button 41 displayed in the operation screen of the operation panel 42 is pressed, the display controller 33 displays a screen on which settings of the job are changeable on the operation screen in the operation panel 42.

The display controller 33 displays an abort button for aborting the execution of the job on the screen on which settings of the job to be temporarily stopped are changeable.

In a case in which the stop button 41 is pressed in a state in which the stop button 41 is not valid, the display controller 33 notifies on the operation screen in the operation panel 42 that the operation of the stop button 41 is invalid.

Here, the state in which the stop button 41 is not valid is, for example, a state in which the execution of the job is impossible due to a failure occurring in the device concerned.

The present embodiment describes the case in which the stop button 41 is a temporarily stop button for temporarily stopping the job in progress, but the disclosure is similarly applicable to a stop button that stops the process in progress.

Next, the operation in the image forming device 10 of the present embodiment will be described in detail with reference to the drawings.

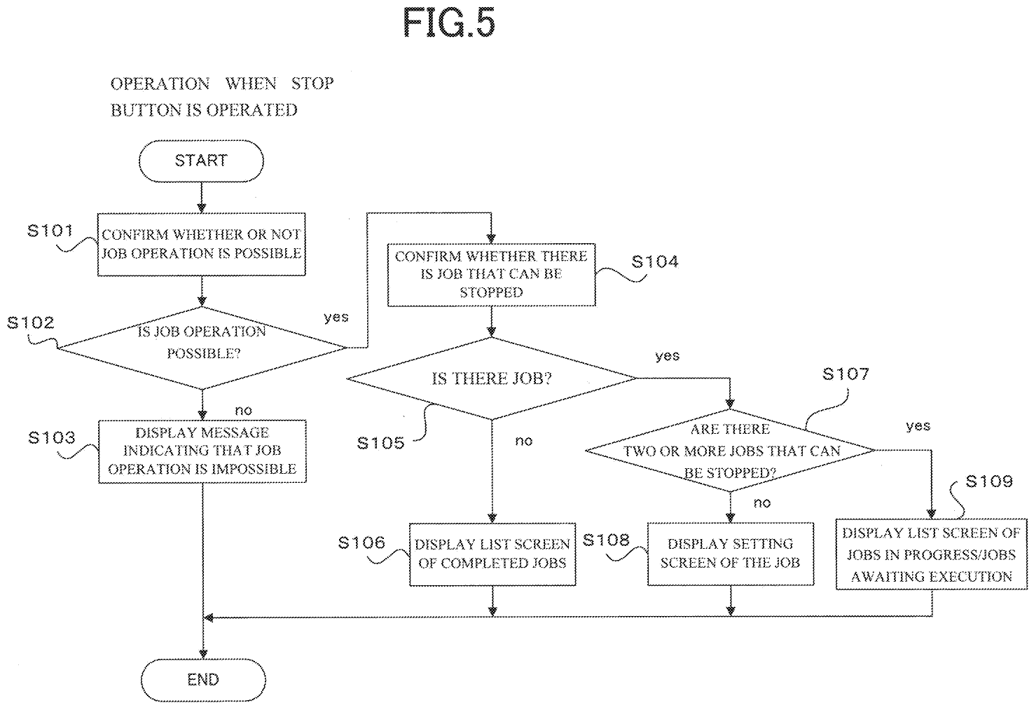

FIG. 5 is a flowchart for describing the operation when the stop button 41 is pressed in the image forming device 10 of the present embodiment.

To begin with, in a case in which the stop button 41 displayed in the operation panel 42 is pressed, the display controller 33 confirms with the job controller 36 whether or not the current state is a state in which the job operation is possible in step S101.

In a case in which it is determined in step S102 that the current state is not a state in which the job operation is possible, the display controller 33 displays a message indicating that the job operation is impossible on the display 34 in step S103.

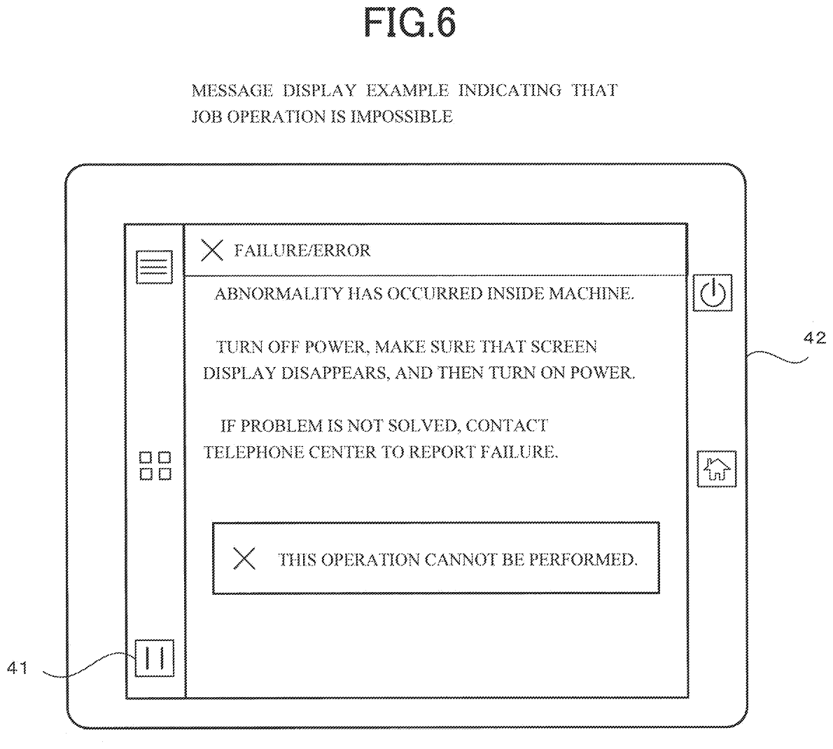

FIG. 6 shows an example of a message displayed in this way indicating that the job operation is impossible. With reference to FIG. 6, since the current state of the device is an error state although the user presses the stop button 41, it can be seen that the text “This operation cannot be performed” is displayed as a message in the operation panel 42.

In a case in which it is determined in step S102 that the current state is a state in which the job operation is possible, the display controller 33 confirms with the job controller 36 whether there is a job that is temporarily stoppable by the stop button 41 in step S104.

In a case in which it is determined in step S105 that there is no job that is temporarily stoppable by the stop button 41, the display controller 33 displays in step S106 a list screen of completed jobs for which the process has already been executed on the display 34.

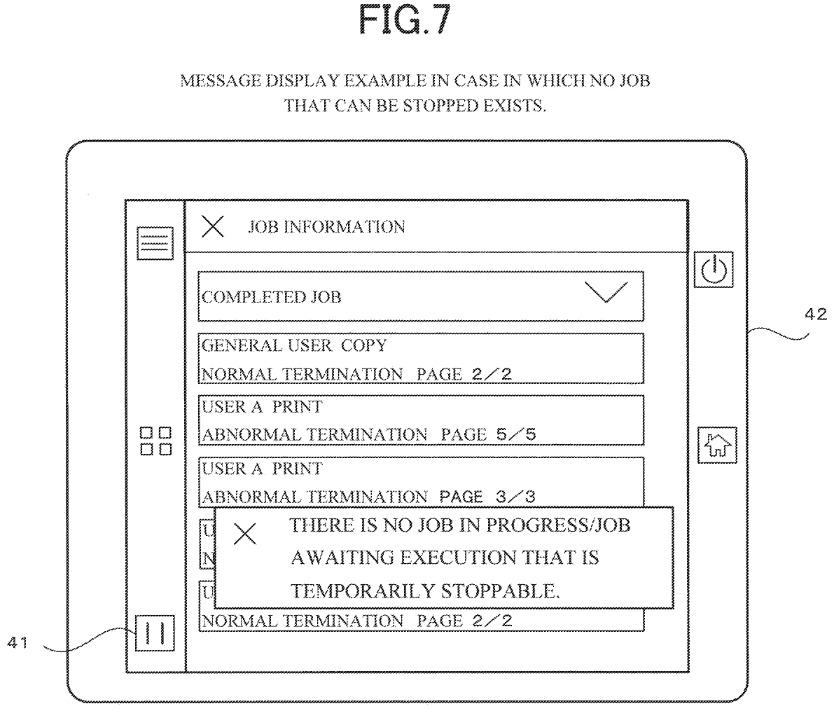

FIG. 7 shows a display example of the list screen of completed jobs displayed in this way. With reference to FIG. 7, it can be seen that a list of jobs for which execution is completed in the past is displayed on the operation screen in the operation panel 42. It can be seen that the text “There is no job in progress/job awaiting execution that is temporarily stoppable” is superimposed as a message on the list of completed jobs in the operation panel 42 in order to notify the user who has operated the stop button 41 that no job that is temporarily stoppable exists.

In a case in which it is determined in step S105 that there is a job that is temporarily stoppable by the stop button 41, the display controller 33 determines whether or not the number of jobs that are temporarily stoppable is two or more. In a case in which there are not two or more jobs that are temporarily stoppable, that is, in a case in which there is only one job that is temporarily stoppable, the display controller 33 displays on the display 34 a setting screen on which the settings of the job are changeable in step S108.

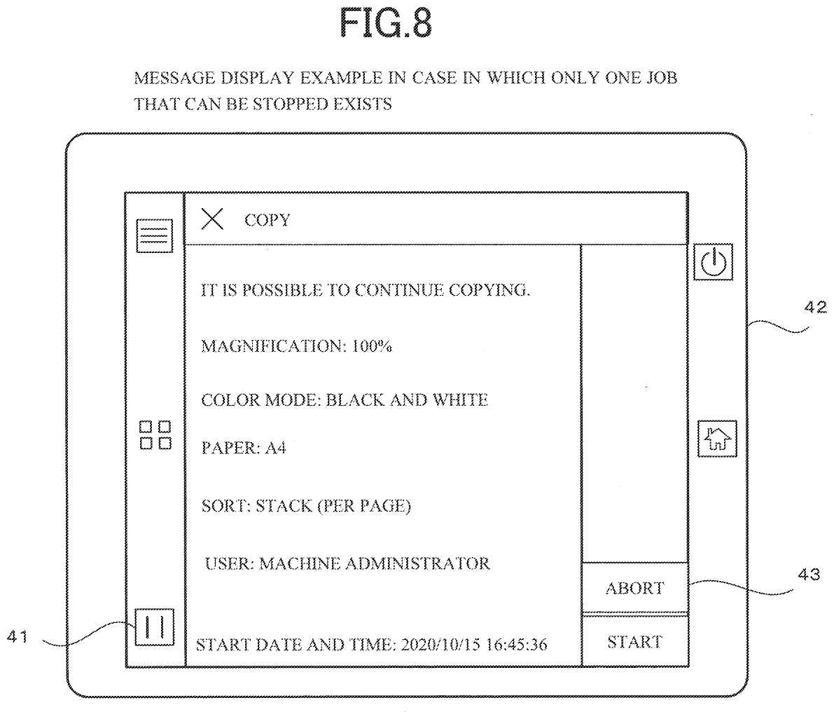

FIG. 8 shows a job setting screen example displayed in this way. With reference to FIG. 8, it can be seen that the screen on which the settings for the job temporarily stopped by the stop button 41 are changeable is displayed as the operation screen of the operation panel 42. The user who has temporarily stopped this job can change the settings by executing an operation on the operation screen and then resume the execution of the job. Furthermore, an abort button 43 for aborting the execution of this job is also displayed in the operation screen example shown in FIG. 8. By pressing this abort button 43, the user can abort the execution of the temporarily stopped job without resumption.

Finally, in a case in which it is determined in step S107 that there are two or more jobs that are temporarily stoppable, in step S109, the display controller 33 displays, on the display 34, a list screen showing a list of jobs in progress temporarily stopped and jobs awaiting execution.

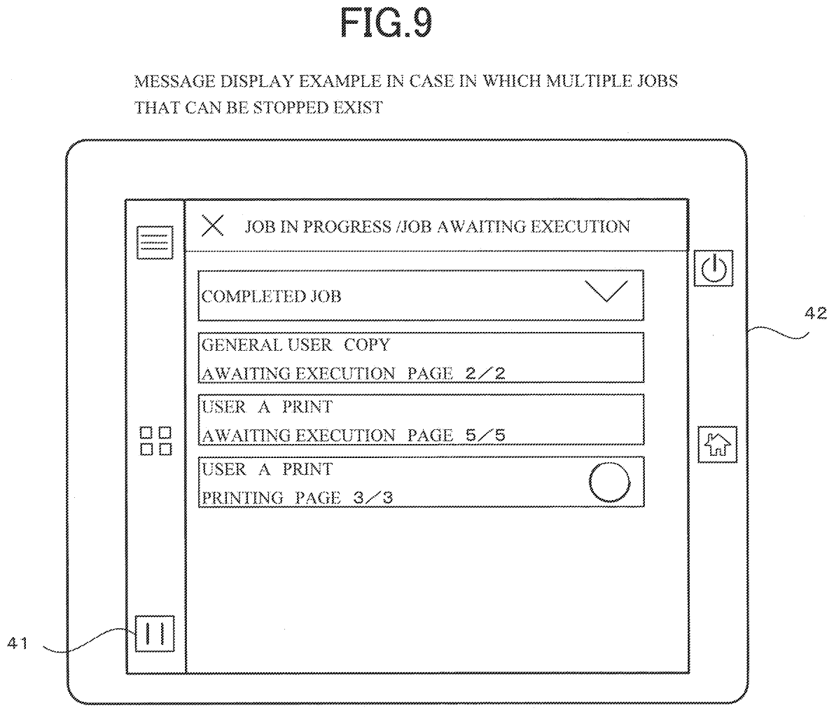

FIG. 9 shows a list screen example of jobs in progress/jobs awaiting execution displayed in this way. With reference to FIG. 9, it can be seen that a list of jobs in progress temporarily stopped by the stop button 41 and jobs awaiting execution to be executed from now is displayed in the operation panel. Note that for jobs whose execution is interrupted by pressing the stop button 41, for example, display showing a state in which the process in progress has been interrupted in the middle is executed by adding a circular display in which density changes in a rotating manner.

Note that when the user selects one job on the list screen of jobs in progress/jobs awaiting execution shown in FIG. 9, the setting screen for each job as shown in FIG. 8 is displayed, and the settings for the job can be changed or the process can be aborted.

In each of the embodiments, the processor refers to a processor in a broad sense, and includes a general-purpose processor (for example, CPU: Central Processing Unit, and the like) and a dedicated processor (for example, GPU: Graphics Processing Unit, ASIC: Application Specific Integrated Circuit, FPGA: Field Programmable Gate Array, Programmable Logic Device, and the like).

The operation of the processor in each of the embodiments is executed not only by one processor, and may also be executed by cooperation of a plurality of processors that exists at physically separated positions. The order of respective operations of the processor is not limited to the order described in each of the embodiments, and may be changed if appropriate.

[Variation]

In the embodiment, the description has been given using the case in which the present disclosure is applied to the image forming device that forms an image on a recording medium. However, the present disclosure is not limited to this case, and the present disclosure can be similarly applied to the information processing device such as a personal computer or a portable terminal device that stores processing execution information for executing preset processing and execute the processing by using the stored processing execution information.

The disclosure of Japanese Patent Application No. 2021-019920 filed on Feb. 10, 2021 is incorporated herein by reference in its entirety. All documents, patent applications, and technical standards described herein are hereby incorporated by reference to the extent that individual documents, patent applications, and technical standards are specifically and individually described to be incorporated by reference.

1. An information processing device comprising a processor,
wherein the processor:
displays a stop button for stopping a process in progress on an operation screen even in a case in which no stoppable process in progress exists;
displays a list of completed processes in a case in which no process to be stopped exists when the displayed stop button is pressed; and
stops the process in progress and displays a list of the stopped process in progress and a process awaiting execution in a case in which the process to be stopped exists when the displayed stop button is pressed.

2. The information processing device according to claim 1, wherein the processor notifies on the operation screen that no stoppable process exists in a case in which no process to be stopped exists when the displayed stop button is pressed.

3. The information processing device according to claim 1, wherein the processor displays a screen on which settings of the process are changeable on the operation screen in a case in which only one process to be stopped exists when the displayed stop button is pressed.

4. The information processing device according to claim 3, wherein an abort button for aborting execution of the process is displayed on the screen on which the settings of the process to be stopped are changeable.

5. The information processing device according to claim 1, wherein in a case in which the stop button is pressed in a state in which the stop button is not valid, the processor notifies on the operation screen that an operation of the stop button is invalid.

6. The information processing device according to claim 5, wherein the state in which the stop button is not valid is a state in which execution of the process is impossible because a fault occurs in the device.

7. The information processing device according to claim 1, wherein the stop button is a temporary stop button for temporarily stopping the process in progress.

8. A non-transitory computer-readable storage medium storing a program executable by a computer to perform processing comprising:
displaying a stop button for stopping a process in progress on an operation screen even in a case in which no stoppable process in progress exists;
displaying a list of completed processes in a case in which no process to be stopped exists when the displayed stop button is pressed; and
stopping the process in progress and displaying a list of the stopped process in progress and a process awaiting execution in a case in which the process to be stopped exists when the displayed stop button is pressed.
